(19) United States
(12) Patent Application Publication
(10) Pub. No.: US 2023/0247040 A1
(43) Pub. Date: Aug. 3, 2023

(54) TECHNIQUES FOR CLOUD DETECTION AND RESPONSE FROM CLOUD LOGS UTILIZING A SECURITY GRAPH

(71) Applicant: Wiz, Inc., New York, NY (US)

(72) Inventors: Ami LUTTWAK, Binyamina, IL (US); Yinon COSTICA, Yinon (IL); Roy REZNIK, Tel Aviv (IL); George PISHA, Giv'atayim (IL); Liran MOYSI, Kfar Saba (IL); Alon SCHINDEL, Tel Aviv (IL)

(73) Assignee: Wiz, Inc., New York, NY (US)

(21) Appl. No.: 18/162,412

(22) Filed: Jan. 31, 2023

Related U.S. Application Data
(60) Provisional application No. 63/267,368, filed on Jan. 31, 2022.

(51) Int. Cl. H04L 9/40

(52) U.S. Cl. CPC H04L 63/1425; H04L 63/1433

(57) ABSTRACT

A system and method for detecting a cloud detection and response (CDR) event from a cloud log. The method includes detecting an identifier of a cloud entity in a cloud log, wherein the cloud log includes a plurality of records generated by a cloud computing environment; detecting a node in a security graph based on the identifier of the cloud entity, wherein the security graph includes a representation of the cloud computing environment; generating a CDR event in response to determining from the security graph that the first node is associated with a cybersecurity threat; and initiating a mitigation action based on the cybersecurity threat.

### CROSS-REFERENCE TO RELATED APPLICATIONS

This application claims the benefit of U.S. Provisional Patent Application No. 63/267,368 filed on Jan. 31, 2022, the contents of which are hereby incorporated by reference.

### TECHNICAL FIELD

The present disclosure relates generally to cloud computing, and more specifically to performing cloud detection and response (CDR) operations in a cloud computing environment.

### BACKGROUND

Cloud computing technologies have allowed to abstract away hardware considerations in a technology stack. For example, computing environments such as Amazon® Web Services (AWS), or Google Cloud Platform (GCP) allow a user to implement a wide variety of software and provide the relevant hardware, with the user only paying for what they need. This shared provisioning has allowed resources to be better utilized, both for the owners of the resources, and for those who wish to execute software applications and services which require those resources.

This technology however does not come without its disadvantages. As the computing environment is now physically outside of an organization, and exposed in terms of access to and from the computing environment, vulnerabilities may be more likely to occur.

While many solutions exist which attempt to block cyberattacks, the reality is that at least some of these attacks will inevitably be successful. An attack may be, for example, unauthorized access to sensitive information, such as information stored in a database. Attacks can be categorized based on severity, for example an attack that merely allows the attacker to see that a file exists on a workload is probably less severe than an attack which allows the attacker to view, or download, that same file.

Detecting threats in a cloud environment may include cloud detection and response (CDR) solutions. Some of these solutions attempt to have a perimeter gateway between the protected environment and external networks. However, this approach is impractical. For example, it is not practical to have all communication in a network pass through a proxy to detect malicious traffic, nor is installing a monitoring agent on every workload always a viable option. Even when it is, such solutions are processor and memory intensive, and add to the overall expense of operating such environments.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting a cloud detection and response (CDR) event from a cloud log. The method also includes detecting an identifier of a cloud entity in a cloud log, where the cloud log includes a plurality of records generated by a cloud computing environment; detecting a node in a security graph based on the identifier of the cloud entity, where the security graph includes a representation of the cloud computing environment; generating a CDR event in response to determining from the security graph that the first node is associated with a cybersecurity threat. The method also includes initiating a mitigation action based on the cybersecurity threat.

Certain embodiments disclosed herein also include a non-transitory computer readable medium having stored thereon causing a processing circuitry to execute a process, the process comprising: detecting an identifier of a cloud entity in a cloud log, where the cloud log includes a plurality of records generated by a cloud computing environment; detecting a node in a security graph based on the identifier of the cloud entity, where the security graph includes a representation of the cloud computing environment; generating a CDR event in response to determining from the security graph that the first node is associated with a cybersecurity threat. The medium also includes initiating a mitigation action based on the cybersecurity threat.

Certain embodiments disclosed herein also include a system for detecting a cloud detection and response (CDR) event from a cloud log. The system also includes a processing circuitry. The system also includes a memory, the memory containing instructions that, when executed by the processing circuitry, configure the system to: detect an identifier of a cloud entity in a cloud log, where the cloud log includes a plurality of records generated by a cloud computing environment; detect a node in a security graph based on the identifier of the cloud entity, where the security graph includes a representation of the cloud computing environment; generate a CDR event in response to determining from the security graph that the first node is associated with a cybersecurity threat. The system also includes initiate a mitigation action based on the cybersecurity threat.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a network log of a cloud based computing environment, in accordance with an embodiment.

FIG. 3 is a role log of a cloud computing environment, utilized to describe an embodiment.

FIG. 4 is another role log of a cloud based computing environment, utilized to describe an embodiment.

FIG. 5 is a security graph, implemented in accordance with an embodiment.

FIG. 6 is a flowchart of a method for generating a cloud detection and response (CDR) alert based on cloud log and a security graph, implemented in accordance with an embodiment.

FIG. 7 is a flowchart for generating a CDR alert based on a cloud log, a policy, and a security graph, implemented in accordance with an embodiment.

FIG. 8 is a schematic diagram of a log analyzer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for cloud detection and response (CDR) to cybersecurity threats. According to an embodiment, a cloud log is accessed to extract therefrom an identifier of a cloud entity. In an embodiment, the cloud log is a network log, role log, event log, a combination thereof, and the like. In certain embodiments, a plurality of events are extracted, each event from one of a plurality of cloud logs. In some embodiments, a policy is applied to the cloud entity, the extracted events, a combination thereof, and the like. In some embodiments, a CDR event is detected based on a plurality of events, each event stored as a record in a different log. In certain embodiments, a mitigation action is initiated in response to detecting the CDR event.

In this regard, it is recognized that applying a condition of a policy to a record of an event is something which can be accomplished by a human. However, a human is incapable of objectively applying the criteria of a policy (e.g., a policy rule, condition, exceptions thereto, and the like) in a reliable manner over time. Furthermore, a human is incapable of extracting event information from a plurality of cloud logs, where even a relatively simple network architecture generates hundreds of events per second.

In an embodiment, the present disclosure solves at least these problems by providing a system that applies policies using objective criteria in a consistent and reliable manner across multiple cloud logs for each cloud computing environment.

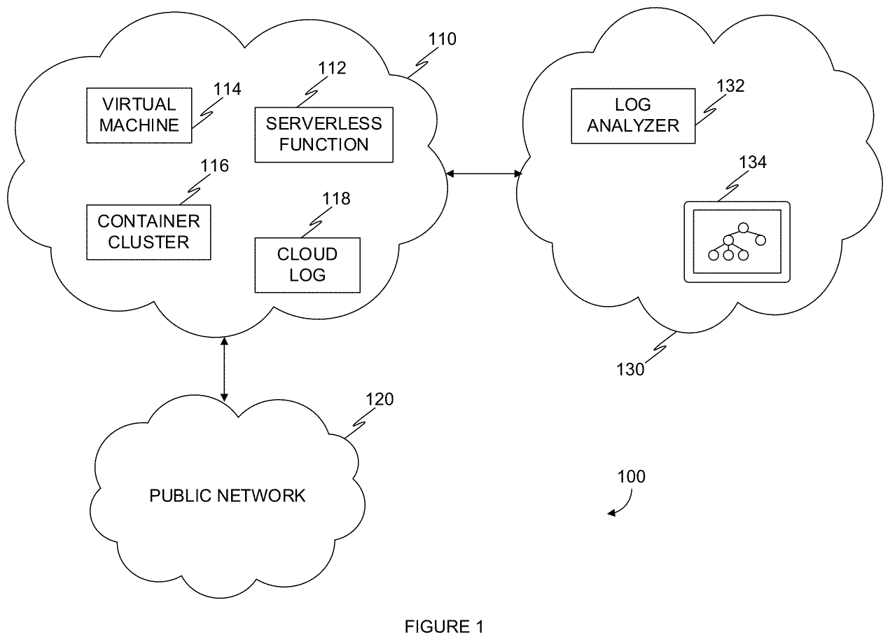

FIG. 1 is an example network diagram 100 utilized to describe the various disclosed embodiments. In the example network diagram 100, two cloud environments are shown for simplicity, though it should be readily apparent that different configurations of computing environments may be utilized without departing from the scope of this disclosure.

In an embodiment, a production environment 110 is implemented on a first cloud computing environment. The first cloud computing environment is, according to an embodiment, deployed on a cloud computing infrastructure such as Amazon® Web Services (AWS), Google® Cloud Platform (GCP), Microsoft® Azure, and the like. A production environment 110 is a computing environment which provides resources, services, and the like, for example to client devices.

In certain embodiments, the production environment 110 is implemented as a virtual private cloud (VPC) in AWS, as a Virtual Network (VNet) in Azure, and the like. A production environment 110 is utilized as the main environment from which an organization operates, and may provide services, according to an embodiment. This is to differentiate, in certain embodiments, from a staging environment, which is substantially identical to the production environment, but is used for testing purposes in order to test services, workloads, policies, and the like, before implementing them in a production environment.

In an embodiment, the production environment 110 includes a plurality of resources. A resource is a cloud entity which provides a service, exposes a hardware resource (e.g., a processor, a memory, a storage, and the like), performs an action in a cloud computing environment, and the like. In an embodiment, the resource is a workload, such as a serverless function 112, a virtual machine 114, a software container cluster 116, and the like. In some embodiments the resource is a software application deployed on a workload, an appliance, a web server, a gateway, a web application firewall, and the like. In an embodiment, the production environment 110 includes a plurality of each of a different resource type. In some embodiments, a serverless function 112 is, for example, Amazon® Lambda, a virtual machine 114 is, for example, Oracle® VirtualBox, and a software container cluster 116 is implemented, for example using a Kubernetes® platform, Docker® Engine, and the like.

In some embodiments, the production environment 110 includes a principal (not shown). In an embodiment, a principal is a cloud entity which is authorized to operate on a resource, initiate an action in the production environment 110, initiate an operation on a resource, a combination thereof, and the like. In certain embodiments, a resource is also a principal, for example when operating on another resource. According to an embodiment, a principal is, for example, a user account, a service account, a role, and the like.

In certain embodiments, a workload in the production environment 110 is configured to generate activity which is logged in a network log 118. A network log 118 is implemented, according to an embodiment, as a file that contains events (also referred to as data records), which correspond to actions by one or more applications. In an embodiment, an event is, for example, a user call to an object in the production environment 110, a process call to an object, an authentication attempt, an access request, and the like.

In an embodiment, a service, for example implemented as a serverless function 112, is configured to generate a network log 118 (which is a type of cloud log). The service is configured to monitor at least a workload in the production environment 110 and write events to the network log 118. In an embodiment, an event is added to the network log 118 as a record, for example based on a predetermined data structure.

In some embodiments, the production environment 110 is communicatively coupled with a public network 120, such as the Internet, and an inspection environment 130. The inspection environment 130 is implemented, in an embodiment, as a VPC deployed on a cloud computing infrastructure, such as AWS. In an embodiment, the production environment 110 and the inspection environment 130 are deployed using the same cloud computing infrastructure.

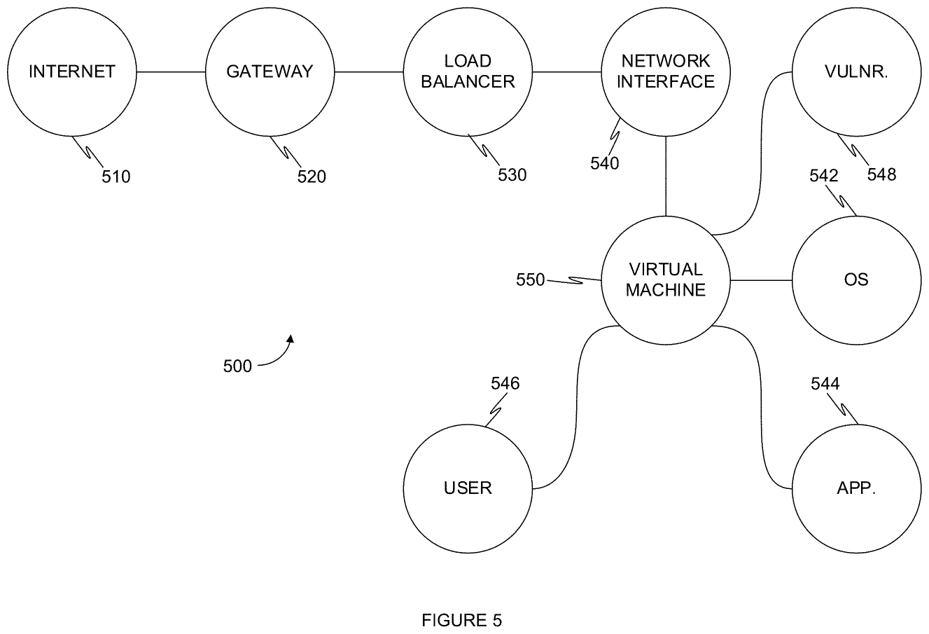

In certain embodiments, the inspection environment 130 includes a log analyzer 132, and a security graph 134. The security graph 134 is discussed in more detail with respect to FIG. 5 below, which is an example of a portion of a security graph. In an embodiment, the security graph 134 is stored on a graph database, such as Neo4j®. In an embodiment, the inspection environment 130 further includes a plurality of inspector workloads (not shown), each inspector configured to detect a cybersecurity object in a workload of the production environment. According to an embodiment, a cybersecurity object is a malware object, a password, a certificate, an application, a vulnerability, an exposure, a misconfiguration, a combination thereof, and the like. In an embodiment, the log analyzer 132 is implemented as a workload, such as a node in a software container.

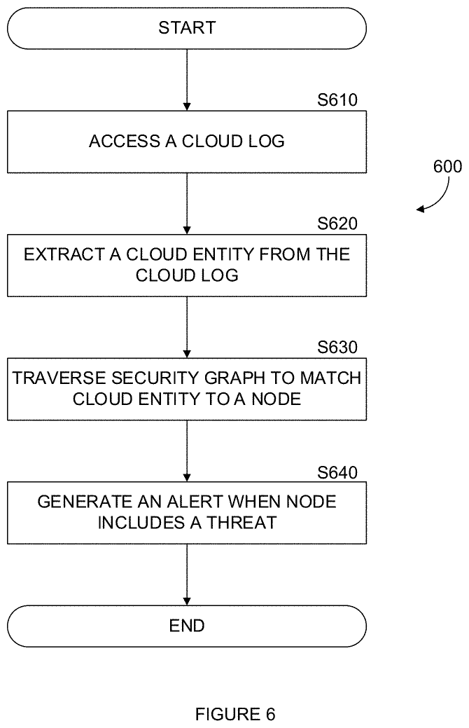

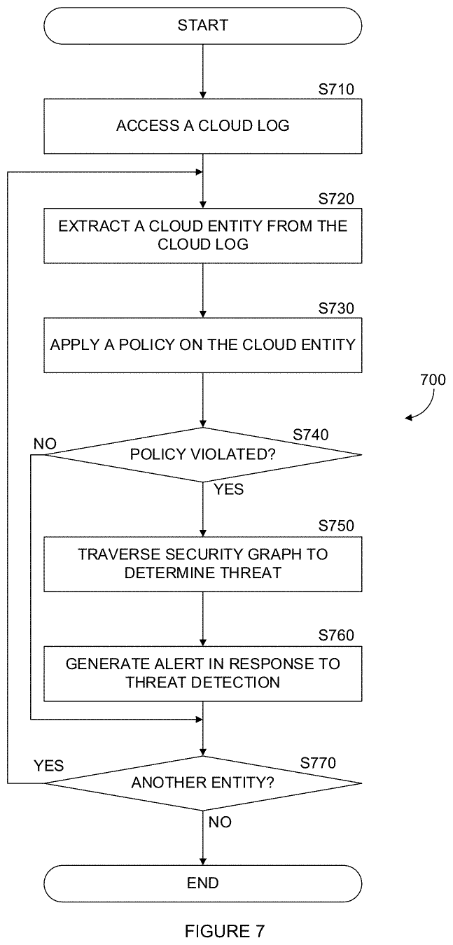

The log analyzer 132 is configured to access cloud logs, network logs, and the security graph 134. In an embodiment, the log analyzer 132 is configured to generate an alert based on any one of: a cloud log, a network log, a role log, a security graph, a combination thereof, and the like. In certain embodiment, the alert includes, for example, a portion extracted from a cloud log, a portion extracted from a network log, a portion extracted from a role log, a combination thereof, and the like, wherein the extracted portion is based on a node from the security graph. An example of a method for generating an alert is described in more detail below with respect to FIGS. 6 and 7.

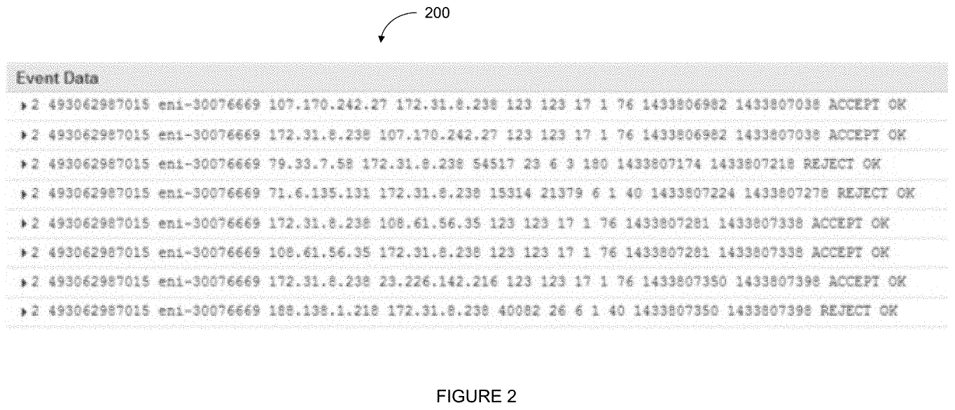

FIG. 2 is an example of a network log 200 of a cloud based computing environment, in accordance with an embodiment. In an embodiment, a network log 200 (a type of cloud log) includes a plurality of events, each event recorded as a row in the log. According to some embodiments, an record includes a plurality of data fields and their values. In an embodiment, an order of a plurality of data fields corresponds to a data structure. In certain embodiments, a data field is, for example, an account identifier, an interface identifier, a source address and a destination address (for network messages), a port, a protocol, a number of bytes transferred, a number of packets transferred, an action (e.g. accept, reject, etc.), a combination thereof, and the like.

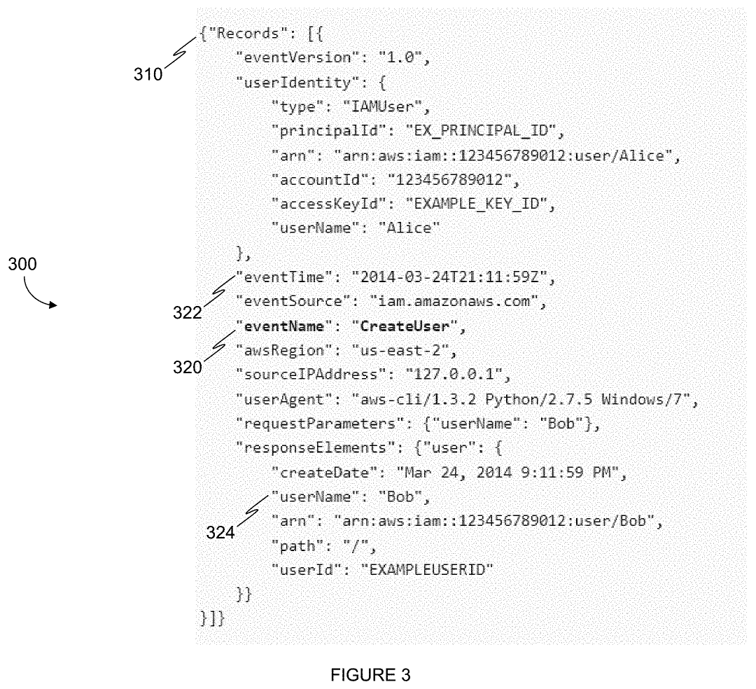

FIG. 3 is an example of a role log 300 of a cloud computing environment, utilized to describe an embodiment. In an embodiment, a role log includes data records which relate to events based on identifiers of principals. In certain embodiments, the role log 300 includes records generated based on events which are associated with user accounts, service accounts, roles, and the like.

For example, according to an embodiment, a first record 310 includes an event by which a new user account was created. The first record 310 includes a plurality of data fields, each data field having a value. In some embodiments, the data field values are unique to an event. For example, the event has an event name 320, which indicates that the event is related to creating a user account, at an event time 322. Other identifiers, such as the username 324 of the created user account are also recorded.

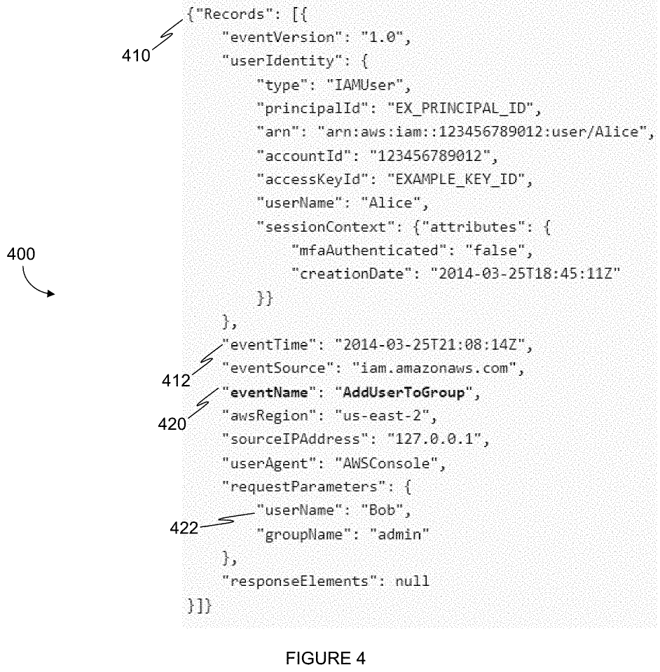

FIG. 4 is another example of a role log 400 of a cloud based computing environment, utilized to describe an embodiment. In an embodiment, a role log 400 includes a second record 410, which indicates that a user “Alice” which previously (based on the event time 412) created a user account “Bob”, added the user account “Bob” to an “Admin” group. The event name 420 indicates that the user account 422 was added to an admin group. Adding administrator accounts is not common, and if it is performed through a machine that includes a vulnerability, as explained herein, this may be an indication that the new administrator-level account is in fact an exploitation.

FIG. 5 is an example of a security graph 500, implemented in accordance with an embodiment. According to an embodiment, a security graph 500 represents a cloud computing environment, such as the production environment 110 of FIG. 1 above, in a graph database, according to a predefined data schema.

In an embodiment, a cloud computing environment is represented in a graph by mapping resources, principals, enrichments, and the like, to nodes in the security graph 500. In an embodiment, a node is generated in the security graph in response to detecting a cloud entity in a cloud computing environment. In certain embodiments, a resource node is generated to represent a resource, such as a workload. In some embodiments, a principal node is generated to represent a user account, a service account, a role, and the like. In an embodiment, an enrichment node is generated to represent an endpoint connection to a public network (e.g. internet), a vulnerability, an attribute of a workload, and the like.

According to an embodiment, an enrichment node 510 represents internet access, such that any node which is connected (e.g. by an edge) to the enrichment node 510, represents a workload which is able to access the internet. In an embodiment, a resource node 520 represents a gateway workload, which is implemented, for example, as a node in a software container cluster. A second resource node 530 represents a load balancer workload, which is connected by an edge to the gateway resource node 520 (representing a gateway resource), and a network interface node 540 (representing a network interface), according to an embodiment.

In an embodiment, the network interface node 540 is connected to a resource node 550 which represents a virtual machine, such as virtual machine 114 of FIG. 1. The virtual machine 114 includes, according to an embodiment, an operating system represented by OS node 542, an application which is executed on the OS of the virtual machine 114, represented by application node 544, a user account node 546 which represents a user account which is tied to the virtual machine 114, and a vulnerability node 548, which represents a vulnerability which was detected as being present on, or pertaining to, the virtual machine 114. A vulnerability is, for example, an outdated software, a specific open port, a user account with high (i.e., excessive) permissions, any combination thereof, and the like, according to an embodiment.

For example, in an embodiment, an inspector is configured to detect a vulnerability on a disk of the virtual machine 114. A node is generated to represent the virtual machine 114 in the security graph (i.e., resource node 550), a node is generated to represent the vulnerability (i.e., vulnerability node 548), and an edge is generated to connected the resource node 550 to the vulnerability node 548, thereby indicating that the virtual machine 114 includes the detected vulnerability.

FIG. 6 is a flowchart of a method for generating a cloud detection and response (CDR) alert based on cloud log and a security graph, implemented in accordance with an embodiment.

At S610, a cloud log is accessed. In an embodiment a cloud log analyzer is configured to access a cloud log of a first cloud computing environment. In some embodiments, the cloud log is, for example, a network log, a role log, an event log, a combination thereof, and the like. In certain embodiments, the cloud log is accessed periodically, in response to a user request, a combination thereof, and the like.

In some embodiments, a plurality of cloud logs are accessed. In certain embodiments, a first cloud log is accessed from a first cloud computing environment, and a second cloud log is accessed from a second cloud computing environment.

In an embodiment, accessing a cloud log includes providing access to, for example by modifying a permission of, a principal such as a service account, a user account, and the like.

At S620, a cloud entity is extracted from the cloud log. In an embodiment, the cloud log analyzer is configured to extract the cloud entity. For example, in an embodiment, a log analyzer is configured to search a cloud log for predetermined keywords (such as “event”, “username”, etc.) and extract a value which is associated with the predetermined keyword (i.e., the cloud entity).

Extracting a cloud entity includes, according to an embodiment, detecting the cloud entity in the cloud log. A cloud entity is, in an embodiment, a workload type (e.g., a virtual machine, a software container, a serverless function, etc.), an application type (e.g., a software application, an appliance, an operating system, a gateway, a load balancer, etc.), a principal (e.g., a user account, a service account, etc.), an enrichment, a vulnerability, a combination thereof, and the like.

In an embodiment, the log analyzer is further configured to determine a relationship between a plurality of cloud entities. For example, in an embodiment, an event record includes an identifier of a virtual machine (workload type) that runs (relationship) a first application (application type) and has (relationship) a user account (principal) with (relationship) certain privileges and is connected to the internet (enrichment).

At S630, the security graph is traversed based on the cloud entity. In an embodiment, traversing the security graph based on the cloud entity includes detecting a node in the security graph having an attribute value which matches an identifier of the cloud entity. In an embodiment, a security graph may be traversed, for example by generating a query to detect a node based on matching an attribute of the cloud entity to an attribute of a node in the security graph. For example, a log analyzer is configured to query a security graph to detect nodes which match the selected cloud entity, based on the extracted cloud entity, according to an embodiment. Node attributes are, for example, a user account name, a role, a group, a workload type, an application type, ab operating system, an IP address, an authentication status, a combination thereof, and the like.

At S640, an alert is generated in response to determining that the node is associated with a threat. In an embodiment, the log analyzer is configured to generate the alert. In an embodiment, cloud entity represented by a node is associated with a threat, for example by determining that the node representing the cloud entity is connected to another node representing a cybersecurity threat, such as a known vulnerability, misconfiguration, exploitation, and the like.

In an embodiment, a misconfiguration is, for example, a database which is not password protected, and should be password protected. A vulnerability on a workload, for example, is not necessarily exploited, or even exploitable, in some embodiments. As an example, in an embodiment, a workload has a vulnerability which allows broad access if exploited, however where the workload is not accessible by an external network, then the vulnerability is not exploitable. It is therefore beneficial to utilize a cloud log to determine if a vulnerability was exploited, for example based on detecting a record indicating an exploit in a cloud log.

In some embodiments, a report is generated which includes an identifier of the cloud entity, a record from the cloud log corresponding to the identifier, a matched node (i.e., an identifier of a node detected in the security graph which matches the identifier of the cloud entity), a combination thereof, and the like.

For example, in an embodiment, a first cloud entity is an unknown user (e.g., user from outside an organization) which is accessing a second cloud entity, such as a database resource. Such an access is recorded as a data record in a cloud log. In an embodiment, the security graph is traversed to detect a node corresponding to the database resource. In certain embodiments, the database resource is found to be misconfigured (e.g., not having a password), and an alert is generated in response to detecting that the database resource includes a cybersecurity threat.

For example, in an embodiment, a node representing the database resource is connected to a node representing a misconfiguration of a type indicating that a database is not secured. In some embodiments, the generated alert includes the record which indicated that the unknown user accessed the database resource.

In certain embodiments, generating an alert based on actual detected exploitation is advantageous, as a vulnerability which is exploited needs to be addressed faster than a vulnerability which is only potentially exploitable.

At S650, a mitigation action is initiated. In an embodiment, a mitigation action includes revoking network access to a resource, revoking network access from a resource, modifying a permission of a principal, generating a ticket corresponding to the alert in a ticketing system, initiating an instruction to update a software on a resource, a combination thereof, and the like. In certain embodiments, the mitigation action is generated based on a detected cybersecurity threat, a determined policy violation, a combination thereof, and the like.

FIG. 7 is an example of a flowchart for generating a CDR alert based on a cloud log, a policy, and a security graph, implemented in accordance with an embodiment.

At S710, a cloud log is accessed. In an embodiment, a cloud log analyzer is configured to access a cloud log of a first cloud computing environment. In an embodiment, accessing a cloud log includes providing access to, modifying a permission of, and the like, a principal, such as a service account, a user account, and the like.

In some embodiments, the cloud log analyzer is configured to assume the service account. The cloud log is, in some embodiments, a network log, a role log, an event log, a combination thereof, and the like. In certain embodiments, the cloud log is accessed periodically, in response to a user request, a combination thereof, and the like. In some embodiments, a plurality of cloud logs are accessed.

At S720, an identifier of a cloud entity is extracted. In some embodiments, the identifier of the cloud entity is extracted from a cloud log, a plurality of cloud logs, and the like. In an embodiment, the cloud log analyzer is configured to extract a cloud entity from the cloud log. For example, in an embodiment, a log analyzer is configured to detect a predetermined keyword (such as “event”, “username”, etc.) in a cloud log, and extract a cloud entity identifier associated with the predetermined keyword.

In an embodiment, extracting a cloud entity includes detecting the cloud entity in the cloud log. A cloud entity is, according to an embodiment, a workload type (e.g., a virtual machine, a software container, a serverless function, etc.), an application type (e.g., a software application, an appliance, an operating system, a gateway, a load balancer, etc.), a principal (e.g., a user account, a service account, etc.), an enrichment, a vulnerability, a combination thereof, and the like.

In an embodiment, the log analyzer is further configured to determine a relationship between a plurality of cloud entities. For example, in an embodiment, an event record indicates a virtual machine (workload type) runs (relationship) a first application (application type) and has (relationship) a user account (principal) with (relationship) certain privileges and is connected to the internet (enrichment).

At S730, a policy is applied to the cloud entity. In an embodiment, applying a policy includes, for example, determining if a value of an attribute of the cloud entity match, exceed, fail, and the like, a value of the policy. In certain embodiments, a policy contains multiple conditions which need to be met in order to pass the policy.

In some embodiments, the policy is applied to a representation of the cloud computing environment which is stored on a security graph. For example, in an embodiment, a policy is applied to a representation of a cloud computing environment by accessing a policy, generating a query based on the policy, executing the query on a graph database hosting the security graph, and determining if the policy is violated based on a result received from the graph database.

At S740, a check is performed to determine if the cloud entity violates the policy. If yes' execution continues at S750, if ‘no’ execution continues at S770. Detecting a policy violation includes, in some embodiments, detecting an access attempt from a source which is predetermined to be a malicious source. In an embodiment, a policy includes a condition stating that an access attempt from a malicious source should never occur, therefore if such access attempts exist, such an attempt is in violation of the policy.

At S750, a cybersecurity threat is detected. In an embodiment, a security graph is traversed to determine a threat based on the cloud entity. For example, in an embodiment, an attribute, a value of an attribute, a combination thereof, and the like, of the cloud entity is utilized to generate a query executable on the security graph to detect a node matching the cloud entity.

In an embodiment, a plurality of matching nodes are found. In some embodiments, the security graph is traversed to determine if the matching node is connected to a node representing a cybersecurity threat, a vulnerability, an exposure, a misconfiguration, a combination thereof, and the like. In certain embodiments, the threat, the vulnerability, the exposure, the misconfiguration, and the like, is stored as an attribute of the matching node. In such embodiments the threat is detected without further detecting in the security graph if the matching node is connected to a node representing a cybersecurity threat.

In certain embodiments, a threat is, for example, public exposure detection, vulnerability detection, database exposure, code vulnerability, endpoint detection, malware detection, misconfiguration detection, a lateral movement detection, an exposed secret, a combination thereof, and the like.

At S760, an alert is generated. In an embodiment, the alert is generated based on an output of traversing the security graph, for example by determining that the matched node is connected to a node representing a cybersecurity threat. In an embodiment, searching the security graph for a node representing a cloud entity which is determined to be suspect based on the cloud logs, it is possible to detect threats which would be otherwise difficult, if not impossible, to detect. This is due, among others, to a large volume of data records available.

In an embodiment, detecting a policy violation by combining sources from a security graph, a cloud log, and a policy is advantageous as it allows to detect such violations in close to real time. Furthermore, by detecting that a cloud entity is associated with a cybersecurity threat based on the representation stored in the security graph, it is possible to determine that the cloud entity is exploited where the cloud entity further violates a policy, in accordance with an embodiment.

At S770, a check is performed to determine if another cloud entity should be extracted from the cloud log. If ‘yes’ execution may continue at S720, otherwise execution terminates. In some embodiments, a plurality of cloud entities are detected and extracted from a cloud log, each of which has a policy, a plurality of policies, and the like, applied to the cloud entity, to a representation of the cloud entity in a security graph, and the like.

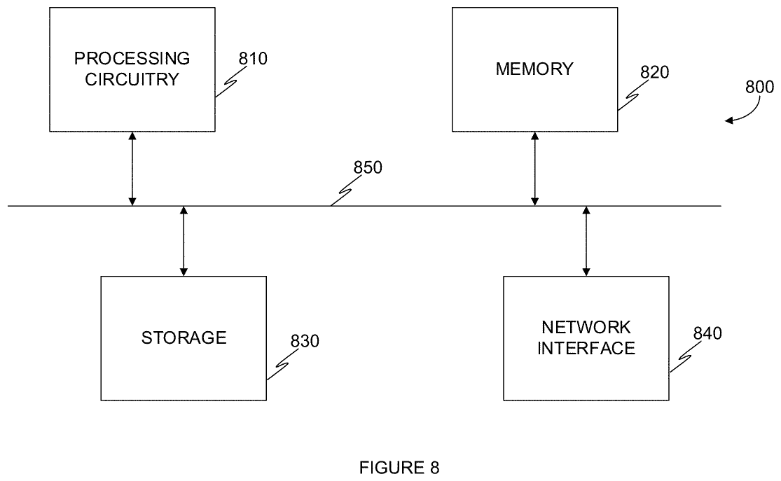

FIG. 8 is an example schematic diagram of a log analyzer 132 according to an embodiment. The log analyzer 132 includes a processing circuitry 810 coupled to a memory 820, a storage 830, and a network interface 840. In an embodiment, the components of the log analyzer 132 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, or any other medium which can be used to store the desired information.

The network interface 840 allows the log analyzer 132 to communicate with, for example, a security graph, a cloud environment, and the like.

It should be understood that the embodiments described herein are not limited to the specific architecture illustrated in FIG. 8, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting a cloud detection and response (CDR) event from a cloud log, comprising:
detecting an identifier of a cloud entity in a cloud log, wherein the cloud log includes a plurality of records generated by a cloud computing environment;
detecting a node in a security graph based on the identifier of the cloud entity, wherein the security graph includes a representation of the cloud computing environment;
generating a CDR event in response to determining from the security graph that the first node is associated with a cybersecurity threat; and
initiating a mitigation action based on the cybersecurity threat.

2. The method of claim 1, further comprising:
detecting the identifier of the cloud entity in a record of the cloud log;
detecting the identifier of the cloud entity in a record of a second cloud log; and
generating the CDR event in response to determining that the record of the cloud log and the record of the second log indicate together a cybersecurity threat.

3. The method of claim 1, further comprising:
parsing each record of the plurality of records to detect a predetermined data field; and
detecting the identifier of the cloud entity based on a value of the predetermined data field.

4. The method of claim 1, further comprising:
applying a policy to the cloud entity, wherein the policy includes a conditional rule.

5. The method of claim 4, further comprising:
generating the CDR event further in response to determining that the cloud entity is in violation of the applied policy.

6. The method of claim 1, further comprising:
generating a query based on an attribute of the cloud entity; and
executing the query on the security graph.

7. The method of claim 6, further comprising:
detecting a node representing the cybersecurity threat, wherein the node representing the cybersecurity threat is connected to a node representing the cloud entity.

8. The method of claim 7, wherein the cybersecurity threat is any one of: a vulnerability, a misconfiguration, a public exposure detection, a vulnerability detection, a database exposure, a code vulnerability, an endpoint detection, a malware detection, a misconfiguration detection, a lateral movement detection, an exposed secret, and any combination thereof.

9. The method of claim 1, further comprising:
initiating the mitigation action to include any one of: revoking network access to a resource, revoking network access from a resource, modifying a permission of a principal, generating a ticket corresponding to the alert in a ticketing system, initiating an instruction to update a software on a resource, and a combination thereof.

10. A non-transitory computer readable medium having stored thereon instructions for causing a processing circuitry to execute a process, the process comprising:
detecting an identifier of a cloud entity in a cloud log, wherein the cloud log includes a plurality of records generated by a cloud computing environment;
detecting a node in a security graph based on the identifier of the cloud entity, wherein the security graph includes a representation of the cloud computing environment;
generating a CDR event in response to determining from the security graph that the first node is associated with a cybersecurity threat; and
initiating a mitigation action based on the cybersecurity threat.

11. A system for detecting a cloud detection and response (CDR) event from a cloud log, comprising:
a processing circuitry; and
a memory, the memory containing instructions that, when executed by the processing circuitry, configure the system to:
detect an identifier of a cloud entity in a cloud log, wherein the cloud log includes a plurality of records generated by a cloud computing environment;
detect a node in a security graph based on the identifier of the cloud entity, wherein the security graph includes a representation of the cloud computing environment;
generate a CDR event in response to determining from the security graph that the first node is associated with a cybersecurity threat; and
initiate a mitigation action based on the cybersecurity threat.

12. The system of claim 11, wherein the memory contains further instructions which when executed by the processing circuitry further configure the system to:
detect the identifier of the cloud entity in a record of the cloud log;
detect the identifier of the cloud entity in a record of a second cloud log; and
generate the CDR event in response to determining that the record of the cloud log and the record of the second log indicate together a cybersecurity threat.

13. The system of claim 11, wherein the memory contains further instructions which when executed by the processing circuitry further configure the system to:
parse each record of the plurality of records to detect a predetermined data field; and
detect the identifier of the cloud entity based on a value of the predetermined data field.

14. The system of claim 11, wherein the memory contains further instructions which when executed by the processing circuitry further configure the system to:
apply a policy to the cloud entity, wherein the policy includes a conditional rule.

15. The system of claim 14, wherein the memory contains further instructions which when executed by the processing circuitry further configure the system to:
generate the CDR event further in response to determining that the cloud entity is in violation of the applied policy.

16. The system of claim 11, wherein the memory contains further instructions which when executed by the processing circuitry further configure the system to:
generate a query based on an attribute of the cloud entity; and
execute the query on the security graph.

17. The system of claim 16, wherein the memory contains further instructions which when executed by the processing circuitry further configure the system to:
detect a node representing the cybersecurity threat, wherein the node representing the cybersecurity threat is connected to a node representing the cloud entity.

18. The system of claim 17, wherein the cybersecurity threat is any one of: a vulnerability, a misconfiguration, a public exposure detection, a vulnerability detection, a database exposure, a code vulnerability, an endpoint detection, a malware detection, a misconfiguration detection, a lateral movement detection, an exposed secret, and any combination thereof.

19. The system of claim 11, wherein the memory contains further instructions which when executed by the processing circuitry further configure the system to:
initiate the mitigation action to include any one of: revoking network access to a resource, revoking network access from a resource, modifying a permission of a principal, generating a ticket corresponding to the alert in a ticketing system, initiating an instruction to update a software on a resource, and a combination thereof.
